(19) United States
(12) Patent Application Publication
(10) Pub. No.: US 2017/0024479 A1
(43) Pub. Date: Jan. 26, 2017

(54) PROVIDING A WWW ACCESS TO A WEB PAGE

(71) Applicant: Zainul A. Sarkar, Nepean (CA)

(72) Inventor: Zainul A. Sarkar, Nepean (CA)

(21) Appl. No.: 15/285,468

(22) Filed: Oct. 4, 2016

Related U.S. Application Data
(63) Continuation of application No. 12/929,617, filed on Feb. 4, 2011.
(60) Provisional application No. 61/301,858, filed on Feb. 5, 2010.

(51) Int. Cl. G06F 17/30

(52) U.S. Cl. CPC G06F 17/30867; G06F 17/3089

(57) ABSTRACT

A method and a system for providing an Internet access to a web page or a website are disclosed. The files defining the websites are accessed and indexed locally, which allows a publisher or a user of the web site to control the keywords by which the web page or a website can be found on the Internet. The user makes the web page or the website searchable by inputting the index into a search engine available to Internet users. The search engine is adapted to process queries of index input.

### CROSS-REFERENCE TO RELATED APPLICATIONS

The present invention claims priority from U.S. Provisional application No. 61/301,858, filed Feb. 5, 2010, which is incorporated herein by reference.

### TECHNICAL FIELD

The present invention relates to providing World Wide Web access to web pages, and in particular to providing multi-lingual World Wide Web access to web pages using a multi-lingual web search.

### BACKGROUND OF THE INVENTION

Knowledge propagates on the World Wide Web at an increasing pace. At present, a very large amount of information, covering most areas of human knowledge, is available at numerous websites. Search engines, such as Google™ or Yahoo™, have been developed to search the World Wide Web for required information.

Search engines generally scan the World Wide Web for published websites, moving through website pages with their crawlers and indexing the content of the pages, so people searching the Internet can use keywords to quickly find related content. Search engines maintain a directory of web page universal resource locators (URLs). Depending on built-in rules for accessing “quality” of the URLs, frequency of updates, and other criteria, the search engines schedule revisits to the sites for indexing new or updated content.

Referring to FIG. 1, a typical method 100 of making a web page discoverable on the Internet is presented. At a step 102, a web publisher uploads a web page to a web server. At a step 104, a web crawler finds the web page. At a step 106, the web crawler downloads an hyper text markup language (HTML) file version of the web page. At a step 108, the web crawler indexes the HTML file, that is, creates an ordered list of words contained in the HTML file. At a step 110, an Internet user enters a keyword into a search engine window. If the keyword is present in the index created in the step 108, the search engine will list the web page in search results.

Publishers of websites can use available registration services to inform specific search engines about their web publications, in an effort to alert the search engines of the existence of their website(s). Nonetheless, the entire process of crawling and indexing a website is outside the control of the publishers, who must rely on search engines to index their content. Prominent search engines, such as Google and Yahoo, do not guarantee that a website will be crawled even if has been registered with the search engines. Even if the website is crawled, Google and Yahoo search engines do not necessarily index the published pages. The search engines may crawl a few pages at a time, and it could take several weeks or months before they crawl all the publishers' pages. Publishers who rely on a web search for visitors to access their sites, depend heavily on search engines to include their web pages in the search indices of the search engines.

Rules for indexing web pages (for example, exemplified in Google's “Terms of Service”) are complex and have changed repeatedly over the last few years, making it difficult to meet the listing requirements. To facilitate indexing, Google suggests that a website have a sitemap, a robots.txt file, and a verification code. A wide set of rules exists for structure of web pages relating to the title, description, keywords placement, and so on, as well as a number of rules related to external links, page rank determination, and other rules. These rules help the search engines determine a proper placement of a particular web page in a results page of a web search.

By way of example, Googlebot, Google's web crawler, will crawl a website if and when it finds the website on the Internet. Website owners can ‘expedite’ the process by registering the website with Google. The experience has been that even after the registration has taken place, it takes about 7 to 10 days for the Googlebot crawler to make a first visit to the website after registration. The Googlebot crawler is programmed with many rules to determine whether to crawl the site, how many pages to crawl, how deep to crawl, when to revisit, and so on. The website publisher has no direct control of how, and whether at all, the website will be crawled.

Furthermore, search engine's access to websites for purposes of indexing is limited. Search engines can only access an HTML version of the original files to work with. This is because the search engines operate from remote locations through the Internet and can only access HTML files made available through intermediary web servers and web browsers. This process is designed to handle only HTML versions of files because of the nature of the Internet, web servers, and web browsers. For many websites, the bulk of information stored is not directly accessible in HTML form, and thus it cannot be indexed for a subsequent web search. For example, many websites provide database services to their clients. These websites use specially developed programming languages such as PHP. The PHP code is processed using a specialized PHP software. A PHP server can generate an HTML version of a query result, which is passed to the browser for viewing. The user accessing such a website has an access to the HTML version of the original file, with the data obtained from the database. This HTML version of the file does not have the capabilities of the original PHP file. A search engine cannot crawl the original files of a PHP-implemented website because the nature of the Internet does not permit this type of access.

One of the functionalities frequently provided using a web page format other than HTML is a multi-language functionality. A web page can be translated into another language at a request of a remote user. However, search engines normally cannot request such a translation, because the search indices they generate are only in the language of the original, non-translated HTML pages. As a result, the websites, although providing multi-language services to their clients, are not searchable in foreign languages, because the keywords of the search are only in the language of the original websites.

The need to provide Internet search capability in a multitude of languages has long been recognized. Levine et al. in US Patent Application Publication 2002/0002452 disclose web search using a “pivot” language, preferably a language in which most of the Internet information is available. For example, English can be the “pivot” language. The search queries are translated into the “pivot” language and are searched in that language. The results are translated back into the language of the request.

Turning to FIG. 2, the method of Levine et al. is illustrated by means of a block diagram 200. At a step 202, an Internet user willing to find a web page, selects the language of the web page and enters a key phrase in their language. At a step 204, the key phrase text is converted into an extensible markup language (XML) format. At a step 206, the text is translated into the “pivot” language using machine translation, to obtain a translation result 208. At a step 210. Internet search is performed in the “pivot” language. At a step 212, the search result is translated back into the original language of the requester, and finally at a step 214, the requester (user) receives the translated text.

One drawback of the translation method 200 is that the user has no control over the exact translation of the key phrase. In effect, the actual search is performed in a language that may be foreign to the user, and the results are translated back into the user's language.

Flanagan et al. in U.S. Pat. Nos. 6,993,471 and 7,292,987 disclose a system that translates HTML documents available through the World Wide Web into different languages. HTML documents are translated by machine translation software bundled in a browser. Alternatively, documents are retrieved as needed, translated, and stored on a Web server so user requests are serviced with a document that has been translated from a different language.

Horiuchi et al. in US Patent Application Publication 2003/0212605 disclose a system and method for machine translation by a downloadable client computer program and a machine translation service, executable by remote servers located across the Internet and accessible on a subscription fee basis.

Travieso et al. in U.S. Pat. No. 7,627,479 disclose a system and method for providing translated web content by parsing the content into translatable elements and keeping track of the translated elements in a database, so when the original web page is updated, only the updated elements of the page are re-translated, which speeds up the provision of the translated web pages.

One serious drawback of the above translation methods and systems is that the websites providing on-demand translated content in a variety of languages cannot be immediately found by a search engine, or cannot be found at all. From the website publisher's standpoint, ability to locate the web pages using an Internet search is critical. Furthermore, it is essential for the website publisher to have updated and/or translated web pages searchable and discoverable on the Internet as soon as possible.

It is a goal of the invention to provide a system and method wherein a web publisher has the control of making web pages, including translated versions of the web pages, discoverable on the Internet. The invention allows both the original and/or translated content of a website to be made immediately searchable in any of the translated languages, using keywords in those languages. Furthermore, the invention allows website publishers to simultaneously produce multiple language versions of their web pages that are immediately searchable. As a result, the web pages become more widely accessible by Internet users earlier. Users can search with keywords iii any of the translated languages to find the translated pages.

### SUMMARY OF THEE INVENTION

According to the invention, accessing web files locally using a downloadable client software enables a web publisher to upload and/or translate web pages, as well as to generate web page indices for input into a search engine. The files to be indexed are selected by the website publisher. Once the selected files of the website are indexed, the index is submitted to a search engine which has been adapted to accept and process such information. This is particularly advantageous for multi-language websites because the indices can be created in various languages, enabling language-specific search. The invention allows the publisher of the web pages to control the process of indexing. By way of example, newly updated or newly translated files can be selected for indexing, to make the updated or translated pages immediately discoverable on the Internet.

In one aspect of the invention, a method for providing a World Wide Web access to a web page comprises:

(a) accessing a file defining a first web page, from a local environment of a host of the first web page;

(b) separating the file into content segments;

(c) creating a list of words contained in a selected one of the content segments of step (b), so as to provide a first index corresponding to the selected content segment, for input into a search engine accessible to World Wide Web users;

(d) making the first web page accessible on the World Wide Web; and

(e) inputting the first index into the search engine, thereby making the web page discoverable by the World Wide Web users.

In another aspect of the invention, a system for providing a World Wide Web access to a webpage comprises:

a user computer system suitably programmed for accessing a file defining a first web page, from a local environment of a host of the first web page; and

a central service configured for creating a list of words contained in a selected one of content segments of the file accessed by the user computer system, so as to provide a first index corresponding to the selected content segment, for input into a search engine accessible to World Wide Web users; and for inputting the first index into the search engine, thereby making the web page discoverable by the World Wide Web users.

For scalability purposes, a plurality of the systems can be arranged into a network for providing a World Wide Web access to a web page. The central services of these systems must be configured to share information therebetween.

In another aspect of the invention, a user computer system for providing a World Wide Web access to a web page comprises a client module for accessing a file defining a first web page, from a local environment of a host of the web page,

wherein the user computer system is for use with a central service for providing a World Wide Web access to the web page by: creating a list of words contained in a selected one of content segments of the file, so as to provide an index corresponding to the selected content segment, for input into a search engine accessible to World Wide Web users; and inputting the index into the search engine, thereby making the web page discoverable by the World Wide Web users.

According to another aspect of the invention, a central service is disclosed for providing a World Wide Web access to a web page under control of a user computer system for accessing a file defining a first web page, from a local environment of a host of the first web page, wherein the central service comprises:

a search enabler for creating a list of words contained in a selected one of content segments of the file, so as to provide a first index corresponding to the selected content segment, and for inputting the first index into a search engine; and

a database for keeping records of at least one of: the user computer system; and the file defining the first web page; and

a processor for communicating with the user computer system, the search enabler, and the database.

In accordance with another aspect of the invention, there is further provided a method of submitting a web page to a search engine, the method comprising:

(a) accessing a file defining a web page, from a local environment of a host of the web page;

(b) separating the file into content segments;

(c) creating a list of words contained in a selected one of the content segments, so as to provide an index corresponding to the selected content segment, for input into a search engine; and

(d) providing the index to the search engine.

In accordance with yet another aspect of the invention, there is further provided a method for providing a World Wide Web access to a web page, the method comprising:

(a) accessing a file defining a first web page in a first language, from a local environment of a host of the first web page;

(b) separating the file into content segments;

(c) creating a list of words contained in a selected translated content segment of the content segments of step (b), so as to provide an index in the second language, corresponding to the translated content segment, for input into the search engine;

(d) making a second web page accessible on the World Wide Web, wherein the second web page comprises the translated content segment; and

(e) inputting the index into the search engine, thereby making the second web page discoverable by the World Wide Web users in the second language.

### BRIEF DESCRIPTION OF THE DRAWINGS

Exemplary embodiments will now be described in conjunction with the drawings in which:

FIG. 1 is a flow chart of a prior-art method of making a web page discoverable on the Internet;

FIG. 2 is a flow chart of a prior-art method of searching Internet in a language different from a language of a key phrase of the search;

FIG. 3A is a flow chart of a method of the invention for providing a World Wide Web access to a web page;

FIG. 3B is a flow chart of a method of the invention for providing a World Wide Web access to web pages in different languages;

FIG. 4 is a block diagram of a system for providing a multi-lingual World Wide Web access to a web page using the methods of FIGS. 3A and 3B;

FIGS. 5A and 5B are flow charts of operation of the system of FIG. 4;

FIG. 6 is a flow chart of a process of translating content segments; and

FIG. 7 is a flow chart of a process of posting indices to search engines in XML format.

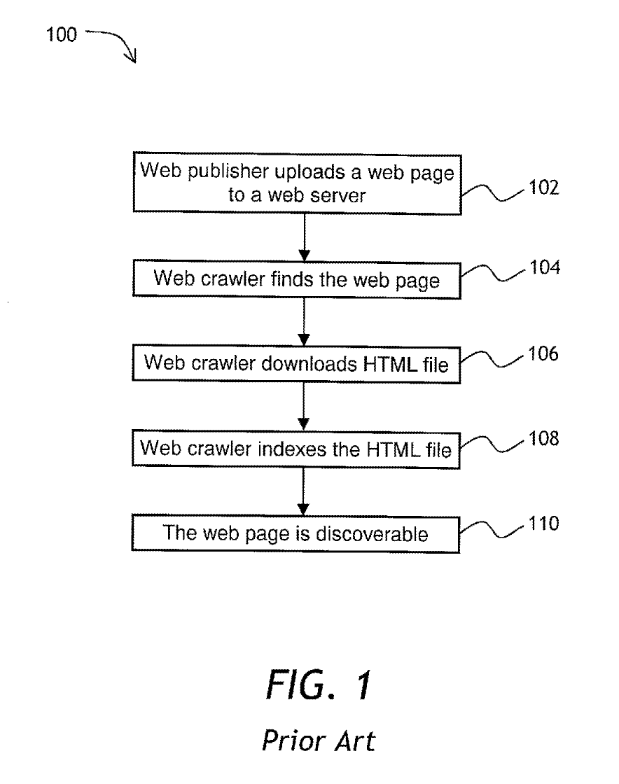

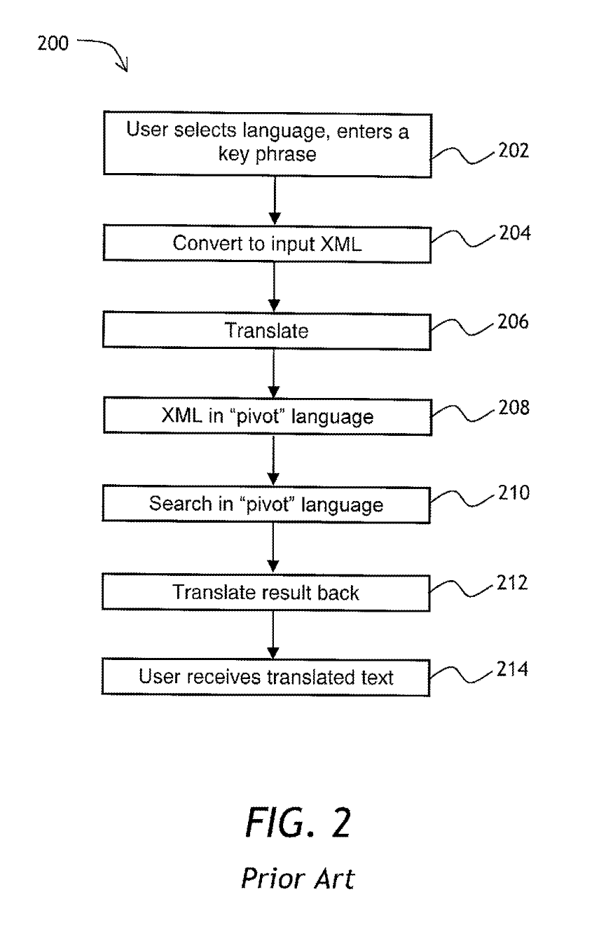

### DETAILED DESCRIPTION OF THE INVENTION

While the present teachings are described in conjunction with various embodiments and examples, it is not intended that the present teachings be limited to such embodiments. On the contrary, the present teachings encompass various alternatives, modifications and equivalents, as will be appreciated by those of skill in the art.

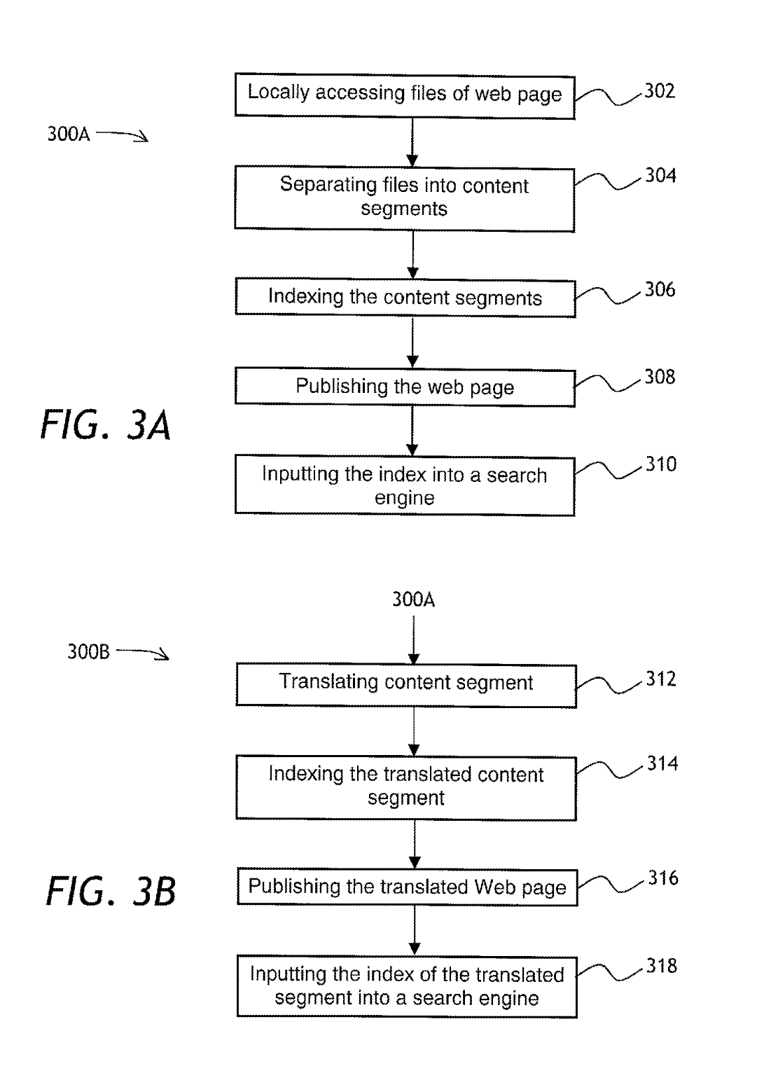

Referring to FIG. 3A, a method 300A for providing a World Wide Web (WWW) access to a web page includes a step 302 of accessing at least one file of a web page, from a local environment of a host of the web page; a step 304 of separating the file into content segments; a step 306 of creating a list of words contained in a selected one of the content segments, so as to provide an index corresponding to the selected content segment; a step 308 of making the web page accessible on the WWW; and a step 310 of inputting the index into a search engine accessible to WWW users, thereby making the web page discoverable by the WWW users. Below, the steps 302 to 310 are considered in more detail.

Step 302 of Locally Accessing Files of the Web Page

The files to be processed are stored in a local directory where a web server (such as Microsoll's Internet Information Server™ or Apache™ web server) is also installed. The location where the files are stored may be on the same computer as the web server, or accessible through a local network, for example a Local Area Network (LAN), to which the user has a permission of electronic access. The local access allows a user to access web page files such as PHP-enabled pages that can connect to databases, but cannot be accessed through the Internet by an external web crawler of a search engine. By selecting which files are to be accessed, a website publisher can control which web pages are published and indexed for searching. Therefore, the user can enable WWW search of the web pages through the web search engine to which the index has been submitted.

Step 304 of Separating the File into Content Segments

Web pages generally contain the main content of the page as well as other incidental information like advertising, menus, and so on. This step separates out the main content from the rest of the information on the web page. These are referred to as “content segments”. The content segments still include special characters like tags, delimiters, and so on, needed later for displaying the segments properly. The content segments include text that can be translated. Preferably, the separating step 304 is performed in the local environment of the first web page host.

Step 306 of Indexing the Selected Content Segment

Search engines operate by crawling pages and creating records in their databases for the crawled web pages. These records typically contain a document 1D, language of the page, URL of the page, title of the page, and an index of the words present on the page. The index is an ordered list (for example, an alphabetic list) of keywords or phrases, accompanied by a reference to the keyword or phrases, for example a page URL of a page where the word is present. According to the present invention, instead of relying on an external web crawler to create such an index, the page is crawled locally at the step 302 and the data for preparing the indices for searching are passed to a central service for placement into a search engine index. This has the benefit of allowing the user to control the content to be indexed for subsequent addition into a search engine, thus allowing the user to control which pages can be found through the search engine.

Step 308 of Publishing the Web Page

At this step, the web page is published on a host web server and the content is ready fro loading into the search engine. The web page is in the same format as the original (such as hypertext markup language (HTML), Active Server Pages (ASP), PHP, ColdFusion (CFM), Java Server Page (JSP), Portable Document Format (PDF,) Text (TXT), or extensible markup language (X M L). This step can be performed simultaneously with the step 310 of inputting the index into the search engine, before, or after the step 310.

Step 310 of Inputting the Index into the Search Engine

At this step, the index is inputted into the search engine. The search engine has to be adapted to be able to process the index for inclusion into the search database of the search engine. An open source search engine called Lucerne, from the Apache Software Foundation, can be adapted for enabling the indices to be input in the database of the Lucerne search engine. Preferably, the Lucerne search engine inputs the index in XML format according to a schema specific to the Lucerne engine. Other engines, and other markup languages can be used as well. Existing established search engines can also be modified to accept index submissions.

Providing Web Access to Web Pages in Multiple Languages

The method 300A for providing web access is particularly beneficial for providing access to web pages in multiple languages. Referring to FIG. 3B, a method 300B of providing web access to web pages in two languages is presented. First, the steps of the method 300A with respect to a page in a first language are performed. Then, at a step 312, a selected content segment is translated into a second language. At a step 314, the translated content segment is indexed, creating an ordered list of words in the second language. This ordered list of words is termed “a second index”. It corresponds to the selected translated content segment. At a step 316, a second web page including the translated content segment is published on the Internet. Finally, at a step 318, the second index is inputted into the search engine, thereby making the second web page discoverable by World Wide Web users in the second language. Below, the steps 312 to 318 are considered in more detail.

Step 312 of Translating the Selected Content Segment

The translation of the selected content segment is preferably performed by parsing the content segment of the separating step 304 into language text elements such as words or phrases. The language text elements are preferably translated into the second language using a third-party automated translation service. The translation is performed by replacing the embedded tags with special markers called tokens that are acceptable to the machine translator. On receipt of the translated content from the machine translator, the tokens are replaced with the related tags so the translated web segments appear the same as the original, except it is now in a different language. A human translator can be used in this process though it will produce results more slowly.

Step 314 of Indexing the Translated Content Segment

This step is similar to the indexing step 306 of the method 300 of providing WWW access, only the indexing is in the second language, allowing a direct web search in the second language.

Step 316 of Publishing the Translated Web Page

This step is similar to the publishing step 308 of the method 300 of providing WWW access, only the publishing is in the second language. The second web page can be published on the same web server as the first web page, or on a different web server.

Step 318 of Inputting the Index of the Translated Segment into the Search Engine

At this step, the index of the translated segment is inputted into the search engine, thus making it possible for a user to perform a search directly in the second language. This step is performed preferably after the publishing step 316, but it can also be performed before that step.

In addition to the advantages offered by user-controlled indexing of web pages, the method 300B for providing multi-lingual access to web pages has the inherent advantage of offering Internet search directly in a native language of a user. When the search is performed directly in the user's native language, the translation of key phrases is not required, which allows the user to perform a more precise search.

In one embodiment of the invention, only indices of translated web pages are provided to a search engine. For example, when an original website already exists, the following steps can be followed to provide a WWW access to a translated web page:

(a) access a file defining a first web page in a first language, from a local environment of a host of the first web page;

(b) separate the file into content segments;

(c) create a list of words contained in a selected translated content segment of the content segments of step (b), so as to provide an index in the second language, corresponding to the translated content segment, for input into the search engine;

(d) make a second web page accessible on the World Wide Web, wherein the second web page comprises the translated content segment; and

(e) input the index into the search engine, thereby making the second web page discoverable by the World Wide Web users in the second language.

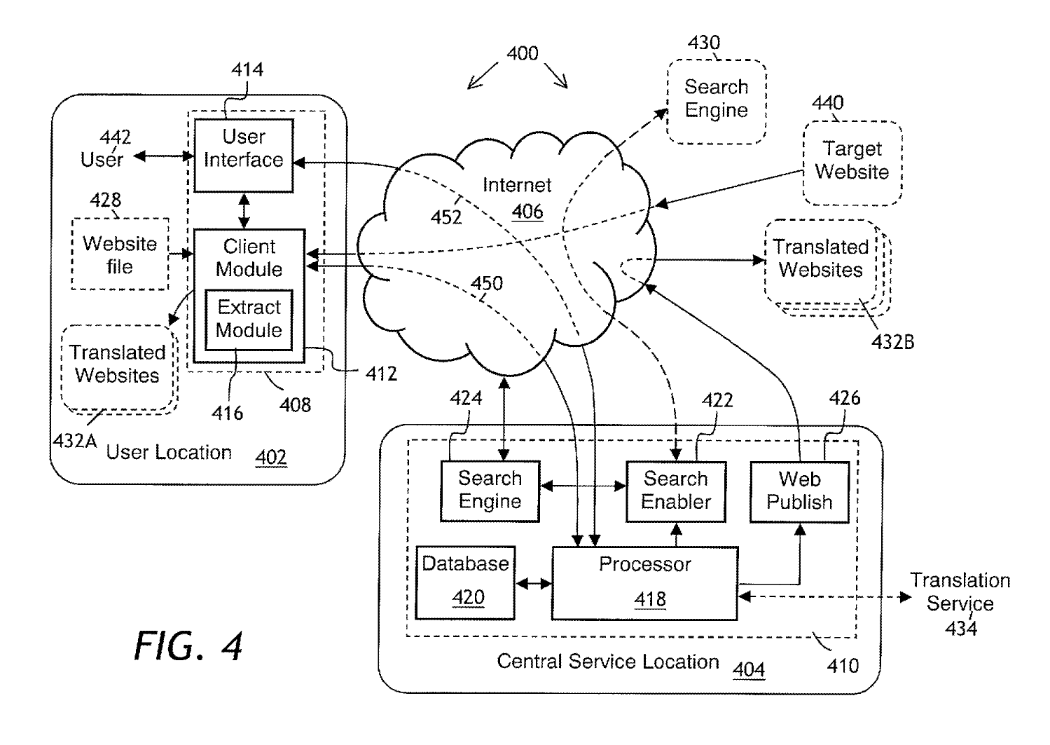

Practical implementations of the above described methods will now be considered. Referring to FIG. 4, a system 400 for providing a multi-lingual World Wide Web access to a web page includes a user computer system 408 at a user location 402 and a central service 410 at a central service location 404, which may be remote from the user location 402. The user computer system 408 communicates with the central service 410 via Internet 406.

The user computer system 408 includes a client module 412 for locally accessing a file 428 defining the web page, not shown, and for separating the file 428 into the content segments, and a user interface 414 for accepting commands from a user 442 to have the client module 412 access and separate the file 428 into content segments; to have the central service 410 provide the index to an internal search engine 424; and to make the web page accessible on the Internet 406. The client module 412 preferably includes an extract module 416 for performing the step 304 of separating the file 428 into the content segments.

The user computer system 408 is suitably programmed for performing the step 302 of accessing the file 428 defining the web page, from a local environment of a host of the web page. For example, the computer system 408 may host the file 428, or the file 428 may be hosted by a web server, not shown, at the user location 402, or at another location connected to the computer system 408 via a local area network (LAN) or an Intranet. In any case, the user must know the Internet Protocol (IP) address where the original web files are hosted, or the Uniform Resource Locator (URL) of the hosted website, along with any user access identification and password that may be required by that networking system.

The user 442 must have access privileges to access the file 428. The file 428 is accessible by the user 442 from the “local” environment such as a LAN or Intranet, or externally via the Internet 406, by authenticating with a username and password. One advantage of the “local” access it that it allows the original files to be accessed, not limiting the capabilities only to HTML page files accessible to a web crawler via the Internet 406, but extending the capabilities to the other file types mentioned above. This local access is referred to as “local crawling” of the hosted website. During the “local crawling”, structural data and the content from the web page source code tags, such as ‘doetype’, ‘lang’, ‘title’, ‘description, ‘metatags’ page URLs (‘href’) and content elements, are collected.

The central service 410 includes a processor 418 for receiving the content segments from the client module 412 via an Internet link 450; a search enabler 422 for indexing the content segment at the indexing step 306 and for inputting the index into the search engine 424 at the step 310 of the method 300A of FIG. 3A; and a database 420 for keeping records necessary for functioning of the system 400, such as records of the computer system 408, of the website file 428, and so on.

The central service 410 is configured for performing the indexing, the publishing, and the index inputting steps 306, 308, and 310, respectively, of the method 300A of FIG. 3A. As noted above, the step 304 of separating the file 428 into content segments is performed by the extract module 416 at the user location 402, but it can also be performed by the central service 410 at the central service location 404. The central service 410 creates the list of words contained in the selected content segment, so as to provide the index for inputting into the internal search engine 424 connected to the WWW, thereby making the web page discoverable by the WWW users. The search engine 424 is “internal”, or in other words, it is a part of the central service 410. Alternatively or in addition, a third-party “external” search engine 430 can be used. The third-party search engine 430 should be made capable of accepting user-generated indices.

The system 400 is a readily and massively scalable system. It can include a plurality of the user computer systems 408 (only one is shown in FIG. 4) connected to the single central service 410 via the Internet 406. In operation, the central service 410 receives and processes the content segments from each of the plurality of the user computer systems 408, indexing the content segments and inputting the indices into the internal search engine 424 and/or the external search engine 430. The database 420 must be designed to keep records of each of the computer systems 408. The more users 442 use the central service 410, the larger the database 420, the more information can be found by the search engines 424 and 430, and the more attractive the system 400 becomes for potential new users. Furthermore, the entire system can be replicated in a parallel implementation that functions essentially in the same way as the original implementation. This is useful, for instance, when the collection of web pages grows to a large size. In this case, the system can be deployed using separate servers for each language.

The client modules 408 are preferably downloadable Java client modules installable at a request submitted to the central service 410. Originally, the users 442 (only one shown in FIG. 4) access the central service 410 through an initial connection 452 via the Internet 406 between the user interface 414 and the central service 410. The user interface 414 is originally a web browser interface, which is used to subscribe users and download the client module 412. Once the client module 412 is downloaded and installed on the user computer system 408, the client module 412 takes the control, communicating with the central service 410 via the Internet link 450. Furthermore, the user 442 can process multiple websites with a single implementation of the Client Module 412. Nothing precludes the user 442 from installing multiple client modules 412 in the same or multiple local or remote environments, for indexing/translating multiple websites in multiple languages if required.

According to the invention, the system 400 is preferably used for providing multi-lingual access to web pages. For providing multi-lingual access, the central service 410 must be configured for performing the steps 312 to 318 of the method 300B of FIG. 3B. Specifically, the central service 410 must be configured for translating the selected content segment into a second language in the translating step 312; creating a second index corresponding to the translated content segment in the indexing step 314; publishing the translated web page or website in the step 316, and inputting the second index into the search engine in the inputting step 3118, thereby making the translated web page or website discoverable by World Wide Web users. Preferably, the translation is performed by a third-party translation service 434 in communication with the processor 418.

Preferably, the central service 410 includes a web publish unit 426 for publishing translated websites 432B on the Internet 406 at a command by the user 442 through the user interface 414, delivered by the client module 412 through the communication link 450. Alternatively or in addition, the translated websites can be hosted at the user location 402, as indicated at 432A. The web server hosting the translated website 432A can be a same web server that hosts the web page in the original language.

A website to be indexed according to the method 300A of FIG. 3A or translated and indexed according to the method 300B of FIG. 3B can be hosted outside of the physical location 402 of the user 442, as shown at 440 in FIG. 4.

It is to be understood that methods 300A, 300B and the system 400 of the invention for providing WWW access to web pages and websites use a local access to file or files defining a web page, which allows the user 442 to control what information is indexed for input into the local search engine 424 and/or the remote search engine 430. The following method of submitting a web page to a search engine is used in the system 400:

(a) accessing the file 428 defining a web page, from a local environment of a host of the web page;

(b) separating the file 428 into content segments;

(c) creating a list of words contained in a selected one of the content segments, so as to provide an index corresponding to the selected content segment, for input into the local search engine 424 or the remote search engine 430; and

(d) inputting the index into the search engine 424 or 430, respectively.

In one embodiment, in step (a), authentication with a user name and a password is required to enter the local environment. Further, in one embodiment, step (b) is also performed in the local environment of the web page host, for example at the user location 402. Preferably, when the web page is defined by a plurality of the files 428 disposed in the local environment of the web page host, a publisher of the web page can select which one of the plurality of files is accessed in step (a), and/or which ones of the content segments of step (b) are indexed in step (c). In this way, the web publisher controls the discovery of the web page via the World Wide Web.

As noted above, each central service 410 can service multiple user computer systems 408. To further improve the processing capability, a plurality of the systems 400 can be arranged into a network. The central services 410 of the systems 400 of the network must be configured to share information contained in the databases 420 of the central services 410.

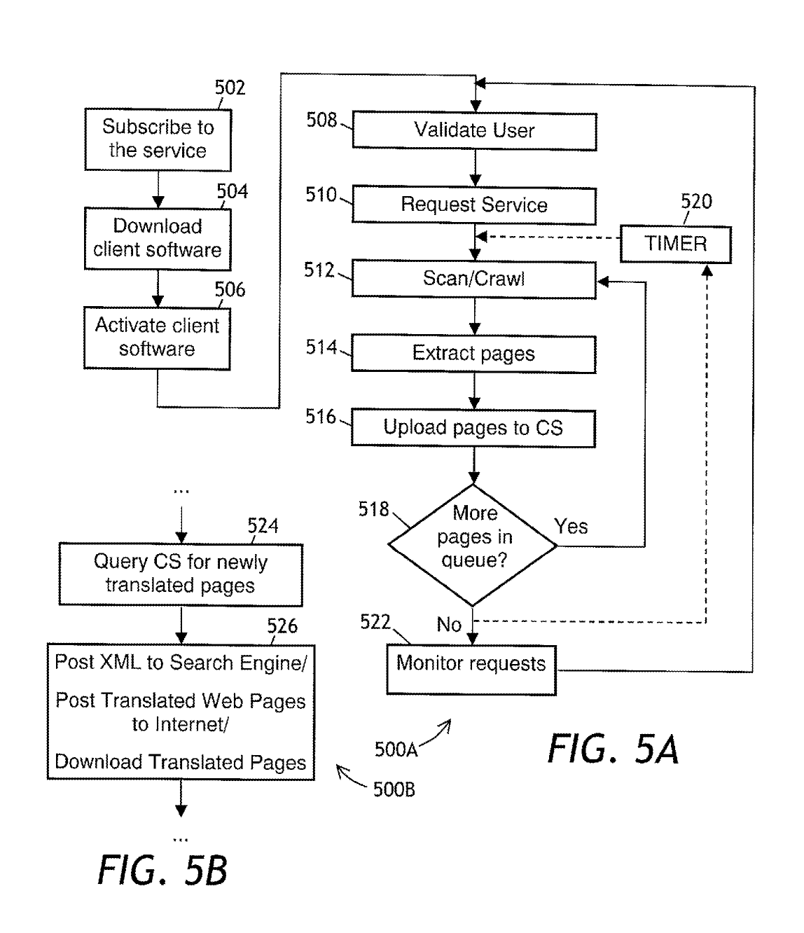

Referring now to FIG. 5A, a flow chart 500A of operation of the system 400 of FIG. 4 is presented. At a step 502, the user 442 subscribes to the service through the user interface 414 in form of an Internet browser window. At a step 504, client software including the client module 412 is downloaded from the central service 410 via the Internet 406. At a step 506, the user software is activated. At this point, the installed client module 412 takes control of the communication with the central service 410. Once the client software is activated, the client module 412 communicates the results of the installation to the central service 410. The fact of successful installation is recorded in the database 420 of the central service 410. At this point, the database 420 has all the client information required to enable the user to start or stop the service, enter new requests, modify the requests, select languages, timing, and local environment of translation. The client module 412, once started, will run continuously transferring information and receiving results form the central service 410 as processing progresses. At a step 508, the user 442 is validated by the central service 410. At a step 510 of “requesting service”, the user 442 selects a website to work with, along with some other parameters described below. At a step 512, the selected website is “crawled” locally, which corresponds to the step 302 of locally accessing the file 428. At a step 514, pages or other content segments are extracted from the selected file 428, which corresponds to the step 304 of the method 300A. At a step 516, the extracted content segments (at least one such segment) are uploaded to the central service 410. At a step 518, a check is performed whether more pages of the website need to be processed. If there are more pages, the control goes back to the crawling step 512, to crawl these pages. If there are no more pages to extract the content from, the processor 418 of the central service 410 monitors incoming requests at a step 522, and/or re-scans the pages of the selected website at time intervals defined by a timer 520 set by the user 442 through the user interface 414, the client module 412, and the Internet link 450.

The process 500A shown in FIG. 5A repeats for each new user that has subscribed to the service, or runs continuously once activated. The user 442 can stop or restart the process 500A at any time. If translation into another language is required, the central service utilizes the third-party translation service 434 to translate the extracted content segments, and the results of the translation are stored in the database 420. An internal translation service may also be used instead of, or in addition to, the third-party translation service 434.

The translated pages can be stored in the database 420 as Binary Large Objects (BLOBs). The BLOB format is used for storage of very large files. The step 512 of crawling the website produces much of the data that would be obtained by crawling the translated pages, with the important components like ‘doctype’, ‘language’ coding, ‘title’, ‘description, ‘metatags’ page URLs (‘href’) having been stored in the database 420. Accordingly, this eliminates the need to crawl the translated web pages in preparation for search engine indexing.

Turning to FIG. 5B, a process 500B of querying of the central service 410 by the user computer system 408 includes a step 524 of querying the central service 410 for newly translated pages. If these are available, the client module 412 automatically invokes the central service 404 to perform a step 526 of: posting an index of the translated pages to the internal search engine 424 or to an external search engine 430 as an XML file; and/or posting translated web pages to the Internet 406 via the web publish unit 426, as the externally hosted translated websites 432B; and/or downloading the translated pages for posting the translated websites 432A to a web server at the user location 402.

In one embodiment of the invention, each service request 510 includes the following elements:

a) Website Reference: This is the address of a website to be processed. It can be a local IP address, a WAN IP address, or a WWW address. Since the central service 410 can process multiple “local” websites, the Website Reference serves the purpose of uniquely identifying each website uniquely.

b) Human or Machine Translation: A request can be for either human translation or a machine-generated translation. A machine translation request can be updated to human translation at any time. A human translation job normally cannot be updated to machine translation after the translation process has commenced.

c) Directory Location: This element sets the location of the website files for the client module 412, so it can locate the website files for local crawling.

d) Languages: The user interface 414 displays a list of the language pairs stored in the database 420, from which the languages for translation can be set.

e) Activate/Archive: This element enables a job to be made active for the “local” crawler. To temporarily or permanently bypass the “local” crawling, the control can be set to “Archived”.

f) Crawler Timing: This control element defines the time for the next visit of the “local” crawler to a particular website. The client module 412 utilizes this element to revisit the website to crawl for updates. The timer 520 is set by the user 442 using this parameter.

g) Search Engine Enabler: The user interface 414 provides links and selection parameters to allow the user 442 to exercise direct control over the generation of the XML documents and posting indices to the search engine(s) available.

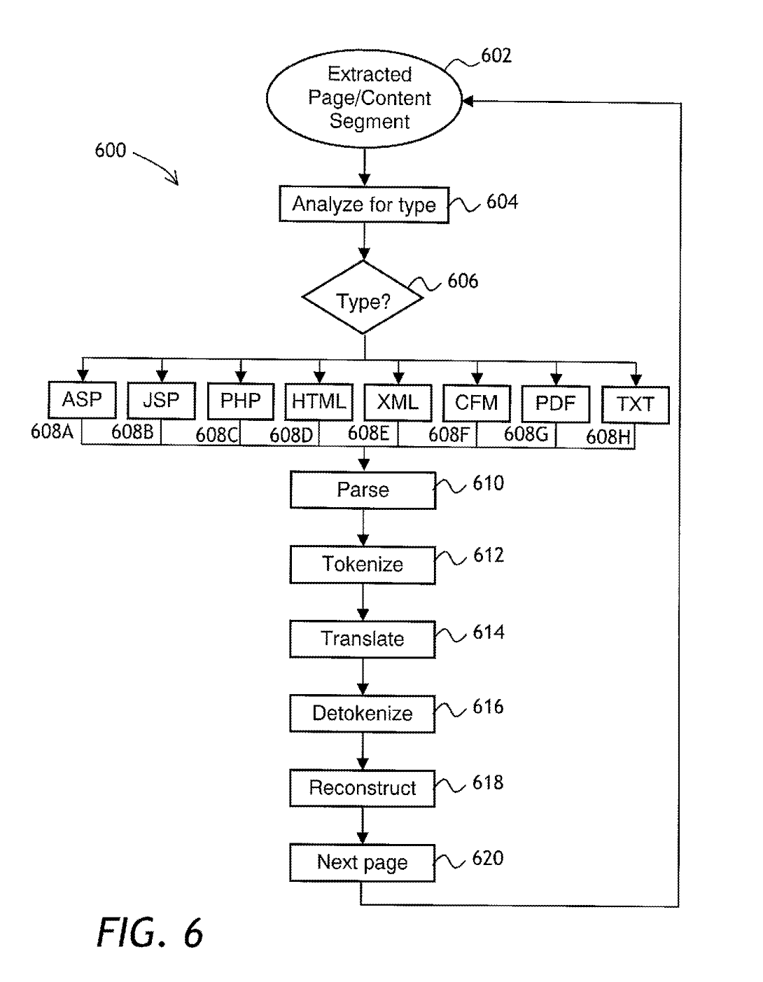

Referring now to FIG. 6, a process 600 of translating content segments is presented. The central service 410 can be suitably programmed to perform the process 600. The process 600 starts once at least one service request 510 is submitted to the central service 410, and at least one content segment is uploaded to the central service 410.

The process 600 of FIG. 6 starts at a step 602 of obtaining a content segment of the file 428. At a step 604, the content segment is analyzed for type. A routing element 606 invokes an appropriate parser for parsing the content segment based on the type of the content determined at the previous step 604. In this embodiment, ASP, JSP, PHP, HTML, XML, CFM, PDF, and TXT type content can be parsed by the parsers 608A 608H, respectively. At a step 610, one of the parsers 608A 608H parses the content segment into language text elements such as words or phrases. At a step 612, the language text elements are tokenized for automated translation. At a step 614, the tokenized language text elements are translated by the external translation service 434. At a step 616, the translated text elements are detokenized. At a step 618, the context segments are reconstructed in the original format, or in another format if required. At this step, a translated web page is reconstructed by incorporating the translated content segment into the page. Finally, at a step 620, next page is selected, and the steps 602 to 618 are repeated.

Below, the process steps 604 to 618 of the process 600 are described in more detail.

Steps 604 to 610 of Content Segment Type Determination and Parsing

Web pages can be of different types. A separate parser module 608A-608H is used for each file type. Each of the parser modules 608A-608H reads the original source code of the page, extracts the structural components such as tag structures or scripts, and stores the content elements in associated tables in the database 420. Upon completion of the parsing step 610, the data is stored in a database table containing the structural elements and associated content elements.

Step 612 of Tokenizing

After the parsing step 610, the language text elements still include hypertext tags required for formatting of the text, for example text size, color, and so on. For machine translation, these need to be removed; and upon translation, they need to be reinserted into the translated text elements, to make the translated text look as closely to the original text as possible. The process of reversibly removing hypertext tags is called tokenization.

Step 614 of Machine Translation

Step 614 of machine translation includes a step of Requesting Translation, and Receiving Translated Blocks. The Requesting Translation step involves establishing an electronic connection with the translation service 434 through a Digital Subscriber Line (DSL), for example and receiving the text blocks for translation. The Receiving Translated Blocks step includes receiving the translated elements with the tokens indicating where the markup tags need to be re-inserted.

Step 616 of Detokenizing

At this step, the original markup tags are re-inserted into the translated text elements.

Step 618 of the Content Segment Reconstruction

During this step, the page code structures such as tags, structural code, and so on, are recombined with the translated text elements to produce the translated web page. The reconstruction process generates a new translated web page for each of the languages requested by the user 442. The resulting pages are in the same format as the original pages. The actual translated files are stored in their respective directories that contain the files related to the request are stored in the database 420.

The reconstructed segments are communicated by the processor 418 to the search enabler 422. Immediately on completion of the reconstruction of a page in a particular language, the central service 410 invokes a process that generates an XML index file according to the schema definition of the local search engine 424 or the remote search engine 430. The reconstructed segments are also communicated by the processor 418 to the web publish unit 426, to move the translated process into a web hosting environment.

The reconstructed segments can be used to formulate the resulting web pages in different presentation styles. At the step 514, the page formatting symbols of the original page source code are stripped. The resulting translated pages can be then be incorporated into a different presentation style for publishing. In this way, the user 442 does not have to use the formats of the original website, although the user 442 can retain the original style if so desired.

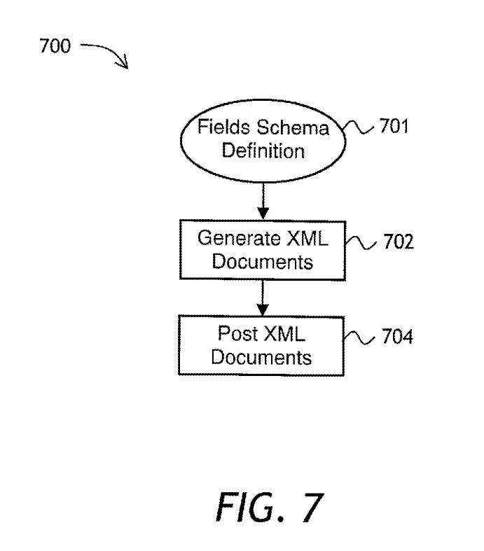

Referring to FIG. 7, a process 700 of posting indices to search engines, such as the local search engine 424 or the remote search engine 430, is shown. In the process 700, XML documents are generated at a step 702 based on a field schema definition 701 for the search engine 424 and/or 430. The generated XML documents are posted to the search engines 424 and/or 430 in a step 704.

The search engine schema 701 can include a document identification code; a language code of the page; a page URL; a page title; a page description; links contained in the page; and an index of the page content. The search engine schema 701 is used to present the indices corresponding to different website files 428 in a standard format. Once the indices are entered into the local search engine 424 or the remote search engine 430, keywords searches can be performed using these search engines to locate the translated websites 432A and/or 432B on the Internet 406.

The foregoing description of one or more embodiments of the invention has been presented for the purposes of illustration and description. It is not intended to be exhaustive or to limit the invention to the precise form disclosed. Many modifications and variations are possible in light of the above teaching. It is intended that the scope of the invention be limited not by this detailed description, but rather by the claims appended hereto.

What is claimed is:

1. A system for making a published web page discoverable by internet searching via an internet accessible search engine, the system comprising:
a publisher's computer system at a user location, a central service computer system at a central service location, and a communication link therebetween; wherein
the publisher's computer system comprises a client module for locally accessing an original file defining the published web page, and crawling the original file to extract content for indexing; and
the central service computer system comprises a search enabling module for indexing the extracted content to generate an ordered list comprising keywords, XML tags, and associated URLs, and for providing the ordered list to be included in a particular search engine that is adapted to accept the ordered list;
thereby making the published web page discoverable when searching via the particular search engine.
